(19) United States
(12) Patent Application Publication
(10) Pub. No.: US 2002/0067406 A1
(43) Pub. Date: Jun. 6, 2002

(54) Door security device

(76) Inventor: Chien-Chuan Chen, Chung-Ho City (TW)

Correspondence Address: Chien-Chuan Chen, c/o Percy International Patent Corp., P.O. Box 1-79, Taipei, TW

(21) Appl. No.: 09/726,354

(22) Filed: Dec. 1, 2000

Related U.S. Application Data
(60) Provisional application No. 60/168,760, filed on Dec. 6, 1999.

(51) Int. Cl. H04N 7/18

(52) U.S. Cl. 348/61; 348/552

(57) ABSTRACT

A door security device mounted on a door having a hole comprises a lens mounted on a fitting, a telescopic tube inserted into the hole secured to the fitting on front of door, a complementary metal oxide semiconductor (CMOS) based image sensor in the rear end of hole for sensing image through lens for converting into image signals, an image processor for processing image signals sent from image sensor, and a liquid crystal display (LCD) for showing the image. With this, advantages such as high safety, low power consumption, adaptability, easy assembly, compact, flexibility, and no damage to door by using existing door hole can be effected.

### BACKGROUND OF THE INVENTION

1. Field of the Invention

The present invention relates to security devices and more particularly to a door security device.

2. Description of Related Art

A typical complementary metal oxide semiconductor (CMOS) has the features of low start-up voltage, low power consumption, high noise margin, and energy saving (e.g., power consumption about 0.6W/hour for CMOS based black-and-white image sensor, and power consumption about 1.1W/hour for CMOS based color image sensor). Also, CMOS based electronics have a relatively long life cycle because CMOS has a low driving voltage and current, and low heat dissipation; a quick signal transmission without significant delay; and near real time image showing after turning on, and thus very safe.

Door security devices have been widely installed in homes during recent years due to rampant burglars, social unrest, and other factors. A simple door security device is the mounting of a magnifying lens (so-called “pipe eye”) through the door. Its drawbacks are narrow view angle, unclear image especially in poor lighting environment, and easily evaded by a burglar which sometimes in turn causes homeowner to open the door to see who is coming without knowing the danger. In view of this, it is very unsafe.

An improved door security device coupled with electronics and monitor has been commercially available. Its deficiencies are high power consumption, warm-up long thus lowering safety, always turned on if a high security required thus consuming energy, and not durable due to susceptible to high heat all of these caused by the mounting of cathode ray tube (CRT) based monitor; and wiring required and thus not possible done by homeowner, i.e., an experienced technician required for help.

A conventional charge coupled device (CCD) based black-and-white image monitor system is shown in FIG. 6 comprising a lens 1, a CCD sensor 2, a signal processor 3, a CRT monitor 4, a timing generator 5, and a video driver 6. This further requires three integrated circuit (IC) based processors (not shown) to work in conjunction with CCD sensor 2, timing generator 5, and video driver 6. It is known that a 200 mA current and a 12V voltage are required to drive the CCD based system. Thus power consumption is large (i.e., 200 mA×12V door 2.4W). The system may generate high heat during operation. Thus it is susceptible to malfunction especially in a closed environment. Note that in fact a battery-operated CCD system only lasts for 3-6 hours. Thus a frequent replacement of batteries is required if do use battery to operate. Thus it is generally not operated by battery. In other words, an AC to DC adapter is required when operating this CCD system. This further causes inconvenience to homeowner due to additional wiring. Thus improvements are required.

A Taiwanese Utility Model Patent Published No. 27,533 discloses an audio-video based watcher device wherein an audio-video based monitor and a light emitting means are mounted within the door, and a transparent glass is provided on the door. This is a hidden watcher device. Further, a lighting is provided to outdoors. But this patent is unsatisfactory for the purpose for which the present invention is concerned for the following reasons:

1. Complex in components.

2. Door has to be disassembled prior to installing.

3. High cost because it is usually required a technician for help.

4. It is required to detach the transparent glass for reparing the watcher device mounted within the door. Thus is very inconvenient.

5. The light emitting means is implemented as bulb, fluorescent lamp, or neon light which typically consumes a high power as well as not durable.

Thus, it is desirable to provide an improved door security device which is easy in use in order to overcome the above drawbacks of prior art.

### SUMMARY OF THE INVENTION

It is therefore an object of the present invention to provide a door security device which is safe, energy saving, and effective.

It is another object of the present invention to provide a door security device has the advantages of simple structure, convenient installment, and causing no damage to door by using the existing hole in the door.

It is still another object of the present invention to provide a door security device has the advantages of powered by a direct current either supplied by battery or transformed from an alternating current source through an adapter, low power consumption, no overheat, not susceptible to malfunction, and no regular maintenance required.

It is a further object of the present invention to provide a door security device wherein an additional voice sensor is provided for amplifying voice in front of door and transmitting the amplified voice to indoor and/or an image recording means is provided for storing visitors' image, thereby increasing safety.

It is still further object of the present invention to provide a door security device which is telescopic adapted to a variety of doors with different thickness.

It is still further object of the present invention to provide a door security device which is operated by an Infrared sensor adapted to night environment and is selectable between an automatic operation mode and a manual operation mode.

It is yet further object of the present invention to provide a door security device wherein an additional radio transmitter is provided for transmitting audio-video signals to a television, a personal computer, and video cassette recorder through space.

The above and other objects, features and advantages of the present invention will become apparent from the following detailed description taken with the accompanying drawings.

### BRIEF DESCRIPTION OF THE DRAWINGS

FIG. 1 is a block diagram of a first embodiment of door security device according to the invention;

FIG. 2 is a sectional view of the device shown in FIG. 1;

FIG. 2A is a sectional view of a second embodiment of door security device according to the invention;

FIG. 2B is an exploded view of the device shown in FIG. 2A;

FIG. 2C is a perspective view of the device shown in FIG. 2A;

FIG. 3 is a block diagram of a third embodiment of door security device according to the invention;

FIG. 4 is a block diagram of a fourth embodiment of door security device according to the invention;

FIG. 5 is an environmental view of the device shown in FIG. 4; and

FIG. 6 a block diagram of a prior art CCD based black-and-white image monitor system.

### DETAILED DESCRIPTION OF THE PREFERRED EMBODIMENTS

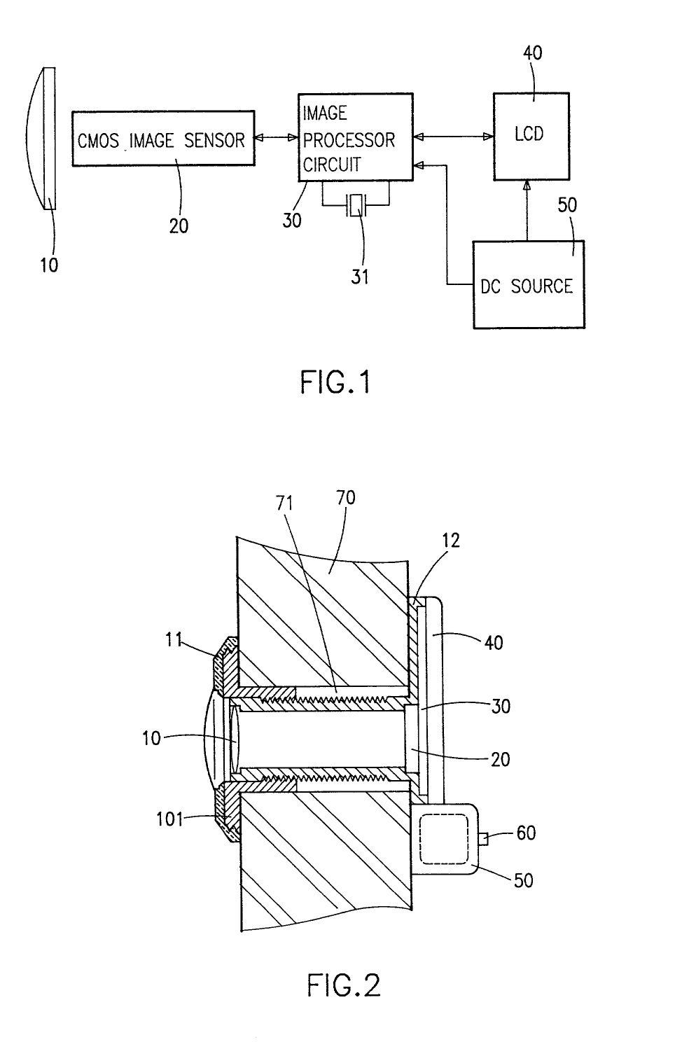

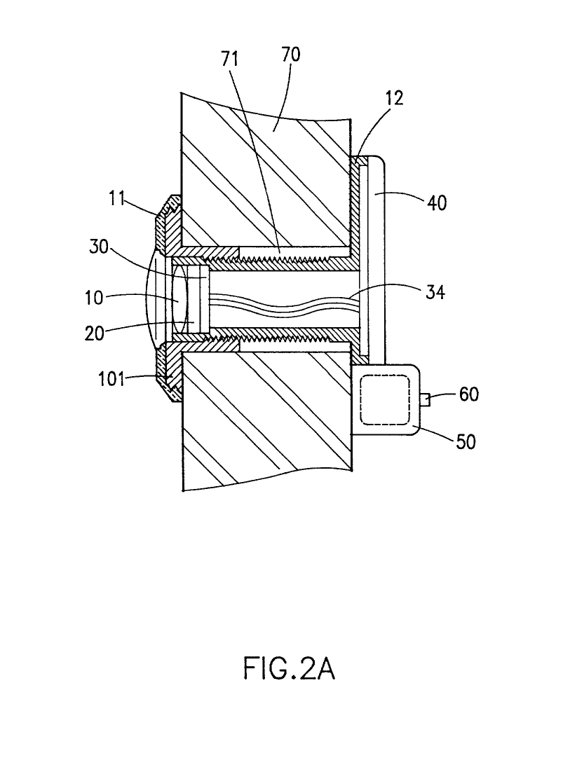

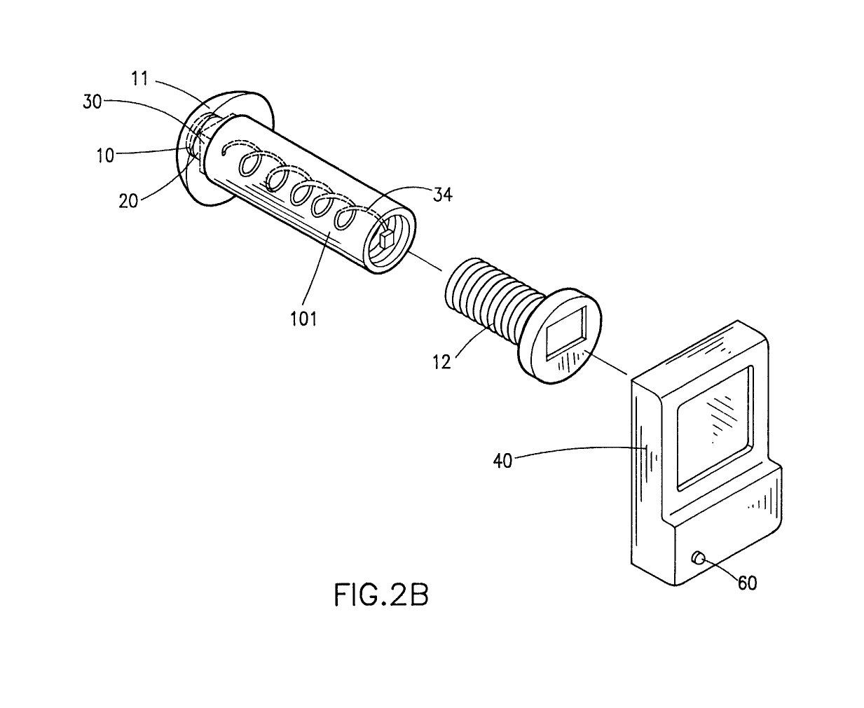

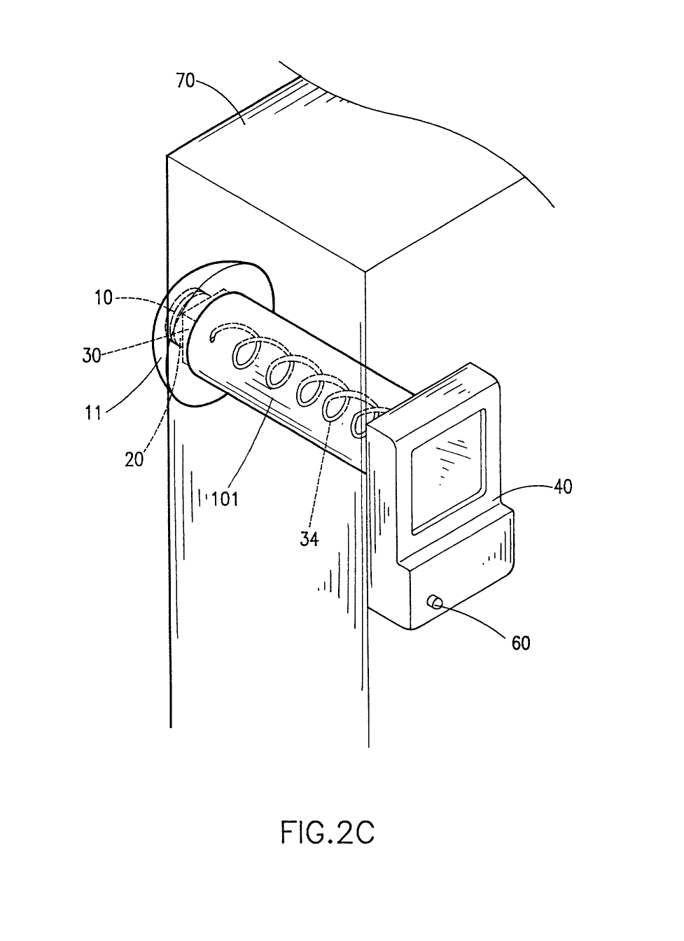

Referring to FIGS. 1-2, there is shown a door security device constructed in accordance with the invention comprising a lens 10, a CMOS based image sensor 20, an image processor circuit 30, a liquid crystal display (LCD) 40, a DC source 50 (e.g., 6V-9V cells or transformed from AC to 6V-9V DC through an adapter), a switch 60, a lens cover 11, and a telescopic tube 12. Lens 10 along with a fitting 101 are mounted on one opening of a hole 71 of door 70. A cover 11 is further mounted on the fitting 101. The telescopic tube 12 is inserted into hole 71 to be threadedly or otherwise secured to fitting 101. CMOS based image sensor 20 is mounted on the circuit board of image processor circuit 30 which is further secured to the opposing opening of hole 71, i.e., the opening of telescopic tube 12. As such, CMOS based image sensor 20 is aligned with lens 10. Thus when switch 60 is on, the image signal of a person in front of door 70 sensed by image sensor 20 is sent through lens 10 to image processor circuit 30. The image signal is processed in image processor circuit 30 to generate an image which in turn sends to LCD 40 to display. The invention is low in power consumption because the image sensor 20 is a CMOS based device in conjunction with LCD 40. In general, a 6V-9V DC source 50 is sufficient to operate the device of the invention. LCD has the advantages of no warm-up and instant display after turning on. A timer 31 is further for setting time and recording image taken time. Referring to FIGS. 2A, 2B and 2C, there is shown a second embodiment of the invention. This embodiment is configured the same as the first embodiment except the following. As shown, lens 10, CMOS based image sensor 20, and image processor circuit 30 are mounted on the left of telescopic tube 12 (see FIG. 2A specifically). The processed image signal is sent to LCD 40 through a signal line 34. The lens 10, image sensor 20, and image processor circuit 30 are mounted in telescopic tube 12 and thus circuit is not affected when cover 11 or telescopic tube 12 is mounted.

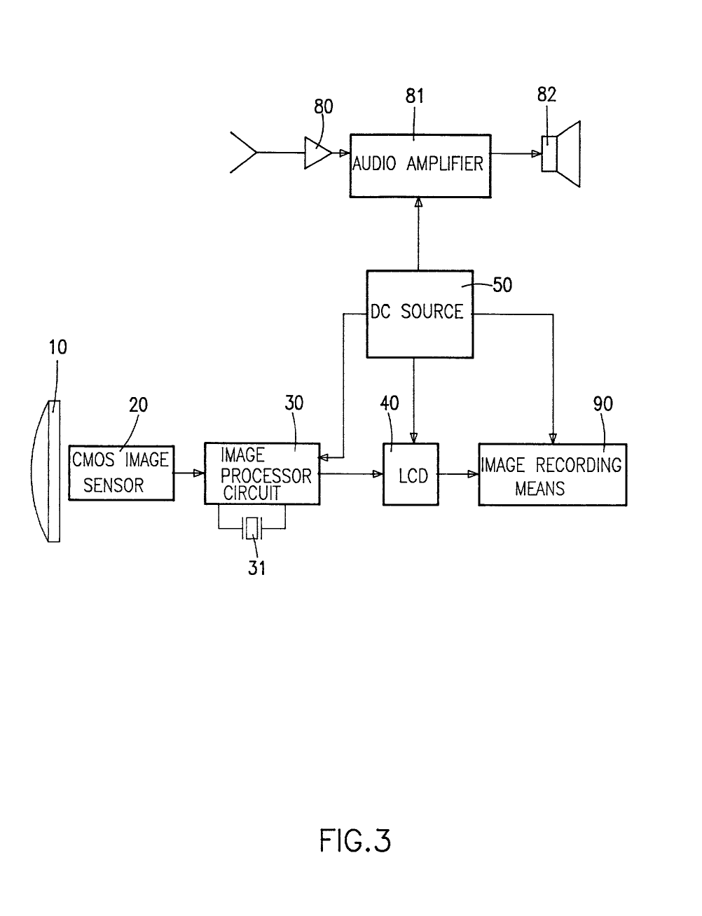

Referring to FIG. 3, there is shown a door security device of third embodiment of the invention. This embodiment is configured the same as the first embodiment except the following. As shown, an additional voice sensor 80 (i.e., similar to a stethoscope or microphone), an audio amplifier 81, and a speaker (SPK) 82 are provided for amplifying voice in front of door and transmitting the amplified voice to indoor. Optionally, an image recording means 90 is provided for storing visitors' image, thereby increasing safety.

Additionally, the threadedly secured fitting 101 and telescopic tube 12 may be designed as turned loose only from behind the door. That is, it is impossible to detach fitting 101 from telescopic tube 12 by turning fitting 101 in front of door. Thus lens 10, image sensor 20, and image processor circuit 30 may not be detached inadvertently.

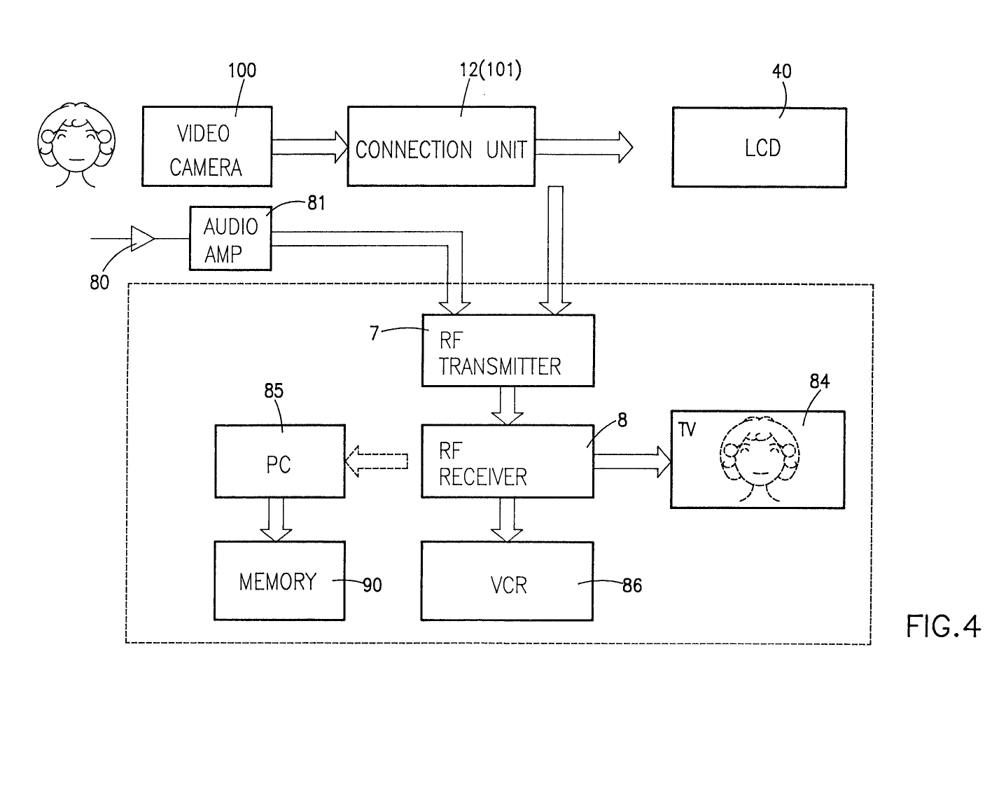

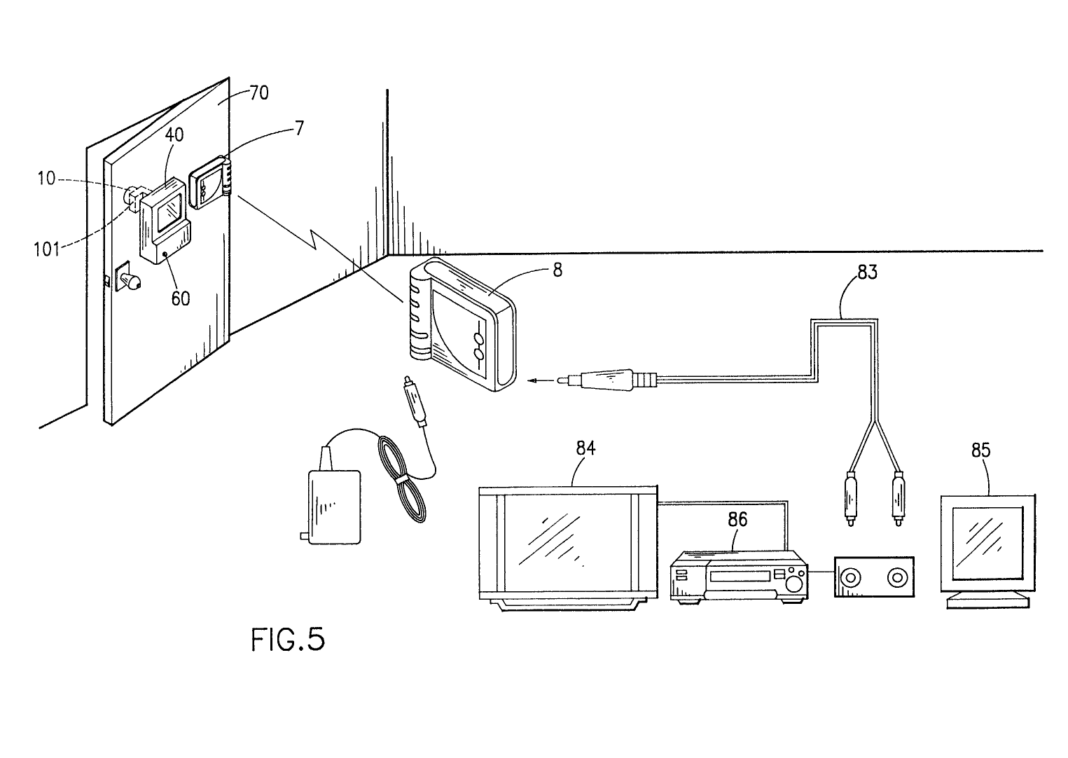

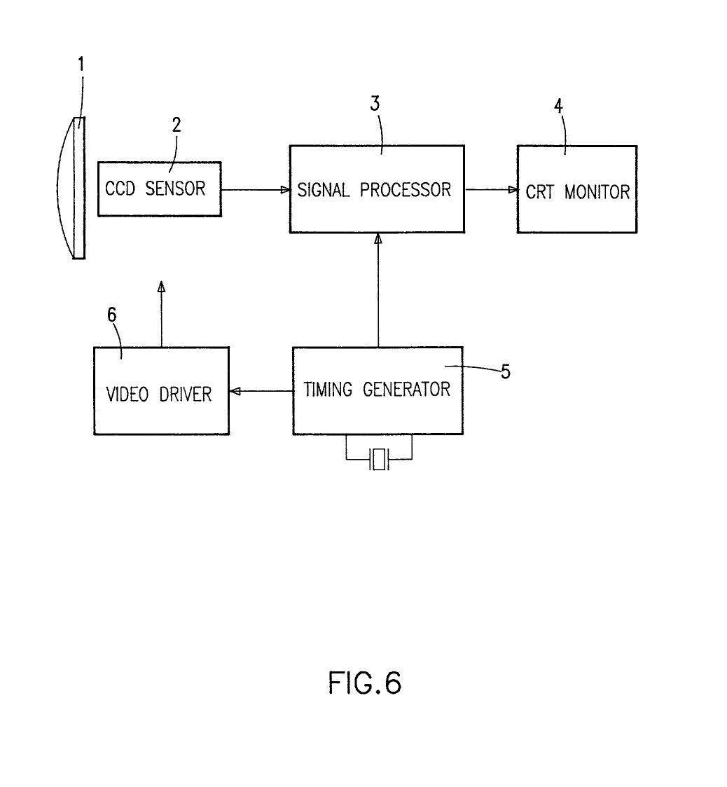

Referring to FIGS. 4-5, there is shown a door security device of fourth embodiment of the invention. This embodiment is configured by combining first, second, and third embodiments. That is, combine radio transmission system, television (TV), personal computer (PC), and video cassette recorder (VCR) to form an automatic door security system. As shown, a radio transmitter 7 is provided in a video camera 100 on door 70. Radio frequency (RF) transmitter 7 is connected to lens 10, CMOS based image sensor 20, video camera 100 of image processor circuit 30, and audio amplifier 81 for retrieving audio-video (AV) signals and transforming into radio signals. Note that the device of the invention is not limited by FCC rules due to short distance between transmitter and receiver and low transmission power. A radio frequency (RF) receiver 8 is provided in a suitable indoor position for receiving the transmitted signal from RF transmitter 7. The received signal is further sent to a TV 84 or a PC 85 through a cable 83 for displaying and monitoring. If desired, a VCR coupled to TV 84 or a harddisk 90 mounted in PC 85 may be used to record or store the picture for future reference. This provides an option of watching TV 84 or PC 85 at home or security space without walking to LCD 40 on door for viewing who is coming.

Additionally, the invention may configure to be operated by an Infrared sensor adapted to night environment and is selectable between an automatic operation mode and a manual operation mode. Further, a mute (i.e., only image is shown) mode and doorbell ringing mode (i.e., for informing homeowner there is someone who wants to enter the room) are available for user to choose.

### ADVANTAGES OF THE INVENTION

The invention has the advantages such as high safety, low power consumption, adaptability, easy assembly, compact, flexibility, and no damage to door by using existing hole in the door.

While the invention herein disclosed has been described by means of specific embodiments, numerous modifications and variations could be made thereto by those skilled in the art without departing from the scope of the invention set forth in the claims.

What is claimed is:

1. A security device mounted on a door having a through hole comprising:
a lens;
a fastening means provided in front of the lens for fastening the lens on a first opening of the hole of the door;
a telescopic tube inserted into a second opening of the hole of the door to be secured to the fastening means;
a complementary metal oxide semiconductor (CMOS) based image sensor provided on the second opening of the hole aligned with the lens for sensing image through the lens for converting into image signals;
an image processor circuit provided in a rear of the CMOS based image sensor being secured to the CMOS based image sensor for processing image signals sent from the image sensor;
a liquid crystal display (LCD) provided in a rear of the image processor circuit being fixed and secured to a back of the door for converting the processed image signals into an image and displaying the image; and
a power source for powering the image processor circuit, the LCD, and the CMOS based image sensor.

2. The device of claim 1, further comprising a voice sensor, an audio amplifier, and a speaker being electrically connected each other for amplifying voice in front of the door.

3. The device of claim 1, wherein the LCD further comprising an image recording means.

4. The device of claim 1, wherein the power source is a connected group of 6V-9V cells.

5. The device of claim 1, wherein the lens further comprises a cover.

6. The device of claim 1, wherein the CMOS based image sensor and the image processor circuit are mounted in a front portion of a telescopic tube engaged with the front of the lens being electrically connected to the LCD through a line.

7. The device of claim 1, wherein the CMOS based image sensor and the image processor circuit are mounted in a rear portion of the telescopic tube.

8. The device of claim 1, further comprising a cable, a radio frequency transmitter, a radio frequency receiver, and a personal computer (PC) having a harddisk wherein the radio frequency transmitter transmits audio-video signals to the radio frequency receiver for receiving, a received signal is sent to the PC through a cable for displaying and storing in a harddisk.

9. The device of claim 1, further comprising a cable, a radio frequency transmitter, a radio frequency receiver, a video cassette recorder (VCR), and a television (TV) wherein the radio frequency transmitter transmits audio-video signals to the radio frequency receiver for receiving, a received signal is sent to a TV through a cable for displaying and to a VCR for recording.
